(19) United States
(12) Patent Application Publication
(10) Pub. No.: US 2008/0312816 A1
(43) Pub. Date: Dec. 18, 2008

(54) Evaluating Method for Identifying Streets to Drive Onto

(75) Inventor: Wolfgang Beier, Weil der Stadt (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/064,226

(22) PCT Filed: Aug. 15, 2006
(86) PCT No.: PCT/EP2006/008043

§ 371 Date: Feb. 19, 2008

(30) Foreign Application Priority Data
Aug. 19, 2005 (DE) 10 2005 039 584.8

(51) Int. Cl. G01C 21/26

(52) U.S. Cl. 701/200

(57) ABSTRACT

The invention relates to an evaluating method for identifying traveled streets, which, for example are subject to a toll, by means of measured values, for example the position and driving direction as detected by the motor vehicle. The course of roads leading to a decision point are recorded in the evaluating device in an exclusive or preponderant manner said courses are re-recorded respectively at a distance from the decision point, where the measured values of sensors arranged in a motor vehicle provide at least one unique value situated within tolerances which makes it possible to unambiguously identify one of the alternative road courses that have been traveled. The invention makes it possible to reliably distinguish between the roads traveled and those that do not lead to the decision point.

The invention concerns an evaluation method for recognition of navigable streets, which are for example toll roads, using values measured in the vehicle such as for example position and direction of travel.

In navigation systems and in particular autonomous street toll data acquisition systems measured values, which can be obtained from sensors of the vehicle, are compared with known data which describes the track or course of the street. From this comparison it is in certain cases to be decided whether a toll road is actually being used. There is a requirement for the quality of this decision to be extremely high, since any erroneous decision either causes a loss in earnings to the road operator or—what, in practice, is perceived to be much more serious—a driver pays for the use of a road which he has not driven on.

In modern processes digital map data is employed, which describes attributes of a street, from which one assumes that a street differentiates itself sufficiently from a side street, so that these are not mistaken for each other. This assumption is verified by driving simulations and actual driving, and certain cases the data is corrected until a satisfactory result is achieved. The data so obtained is then used in actual operation as the basis for a decision algorithm of the system in the vehicles.

In isolated cases it could occur that the measured values which are obtained in the vehicle alone are not sufficient for distinguishing between the course of a toll street and another which is not a toll street or has a different toll. For such situations, so called support short-range data transmitters usually in the form of guide posts are employed, which respectively transmit supplemental information to the vehicle as to only one of the streets to be distinguished, so that complete information is available for the evaluation system to reliably make a decision.

Another possibility would be to relocate the point along a toll road segment at which a decision is to be made further along in the direction of travel. This way, one would have a greater chance of finding sufficient distinguishing characteristics between the two alternative street tracks. This does not in principal solve the problem; however, it reduces the number of the required information transmitting guideposts. In practice, however, such an improvement cannot be realized, since it should be possible also to conduct a spontaneous verification which is not limited to a location along an already “paid” section, and this along the greatest possible extent of the toll road. This leads to the requirement, that the decision point should be located as early as possible along a newly utilized road segment. This however again reduces the probability that in such a short road segment a clear distinction can be made, using vehicle obtained measurement values, between the road and another side road laying in close proximity.

In addition, there are further requirements for the evaluation process, such as a small as possible computation power requirement for the evaluation in a small auxiliary device in the vehicle, wherein the computation power should be distributed as evenly as possible over time.

It is accordingly the task of the invention to develop a suitable process which substantially overcomes the above mentioned problems. This task is solved in a process according to the precharacterizing portion of claim one by the characterizing features of claim one. Further details and advantageous embodiments of the inventive process are set forth in the dependent claims.

The invention will be described in the following on the basis of select examples with reference to the figures and the therein indicated reference numbers.

There is shown in:

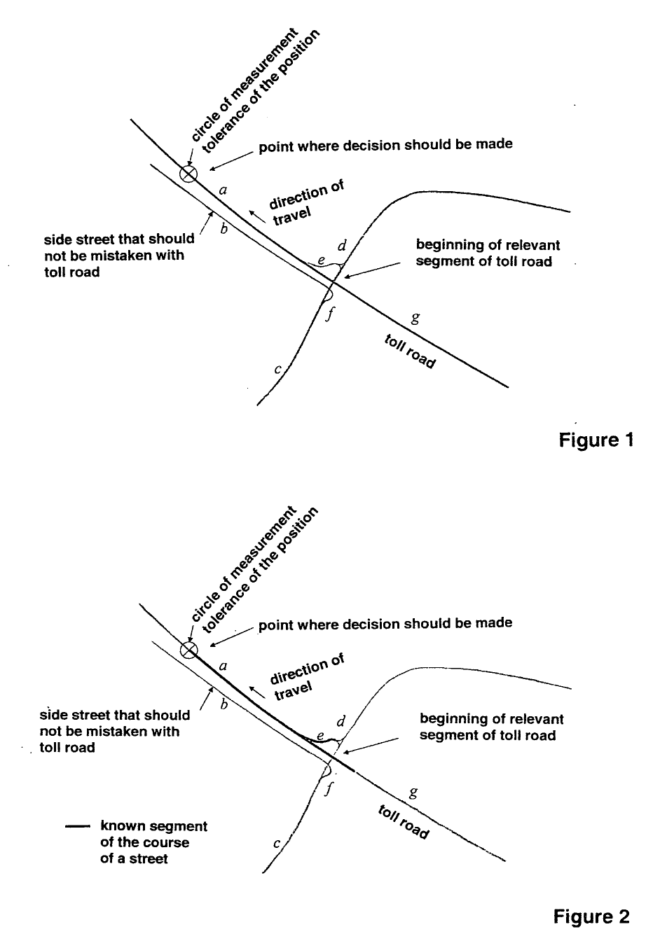

FIG. 1 an example of a problematic decision point.

FIG. 2 a sufficient number of parameters for evaluating the course of the street.

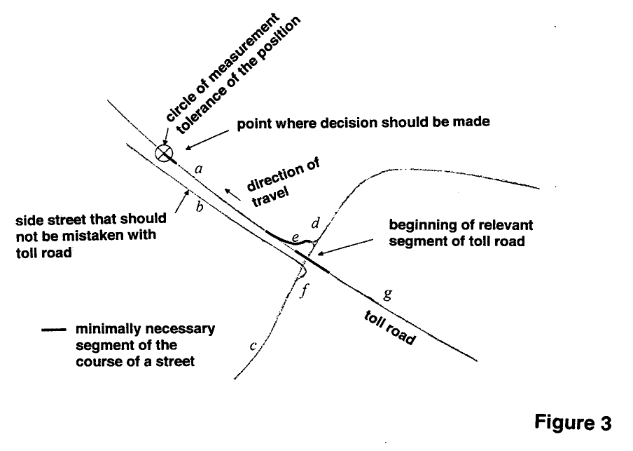

FIG. 3 the necessary and sufficient description for evaluation of the course of the street.

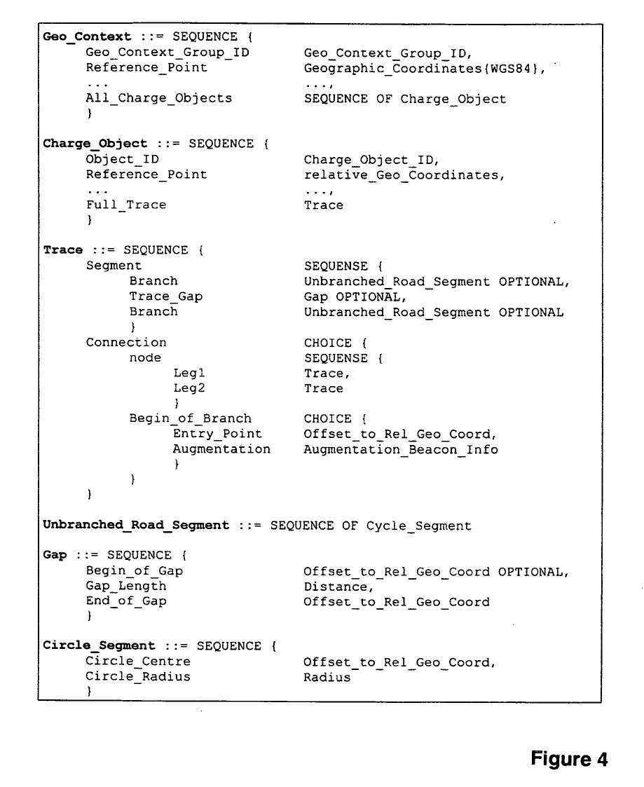

FIG. 4 example of a data description according to the inventive process.

In accordance with the invention, in the memory of the evaluation device a data set is maintained, which describes the course of the toll road going backwards as seen from the decision point relative to the direction of driving. The length of this described segment must be so long, that along this length one feature determinable by the measurement sensors detects the actually driven-on road, which feature is distinct from all other competing road courses in the vicinity. It is not possible at this time, using the vehicle onboard evaluation device, to determine which length of a stored street segment would be sufficient for this parameter, since this depends upon the respective course of all alternative streets. Thus it is the responsibility of the programmer who inputs the data sets for the evaluation device to provide sufficient information regarding competing street tracks in advance as the data set.

If all measurement values regarding the stored track up to the decision point lie within the tolerances of the sensors, then during the evaluation it is assumed that the described street segment is actually being traveled. Thereby it is assumed that no alternative streets exist of which the course is similar enough that one could travel along a longer segment thereof and during this all measurements within the tolerances could appear identical to those on the adjacent toll road.

In the case that the stretch of road under consideration going backwards from the decision point according to the above criteria leads to a branch so that more than one entry or approach exists to the traveled segment, then in accordance with the invention, as the data set, the respective course of the streets is described back to include all branches of this branching and this data set is included in the memory of the evaluation device. Therein, for the necessary length of each of these branches, likewise the condition of the first segment in the vicinity of the decision point applies (that a clear measurement difference exists).

Since however also these branches could again (viewed backwards in the direction of travel) lead to branches, this could result in a tree-like diversification of the data content to be carried along. For this, there applies for the necessary description of the segments of all branches after each other again the condition that the length must be sampled to the extent that the measured values from the sensors (within the tolerances) supply at least one clear result, which can only be associated with the actually traveled (for example) toll road.

For evaluation, in accordance with the invention, the measured values determined by the present sensors such as position, direction and orientation of the vehicle (and in certain cases also the elevation) are compared with data which describe the course of the in certain cases branch-like coming together, possible road courses leading to the decision point. Herein the data preferably is presented in the same form as the measured values, for example, in display format, from which the measured values can be derived, since a conversion can thereby substantially be omitted.

The data, which are made available in the vehicle are preliminarily to be so prepared that they provide the required minimum of information which allows the evaluation logic to clearly recognize the actually traveled segment from a consideration of all segments leading to the decision point by comparison with the sensor measurements. For this, the comparison of the different alternative segments inclusive of branches must be carried out so far back, until there can be no other driven course which does not lead to the decision point which, taking into consideration the measurement tolerances, can be confused with the relevant track.

The comparison between the input measured values and the existing data is preferably so carried out that segments of the (toll) road under consideration, which lie so close to adjacent roads as to be confused therewith (that is, within the tolerances of the sensor values), are less or not at all taken into consideration, and, in contrast, primarily the segments which deviate so far from competing tracks, that they, taking into consideration the sensor tolerances, can be clearly distinguished. Therein also a weighting of the data can occur, in the sense that a grading or categorizing of the relevance of the data with regard to the present (in certain cases vehicle dependent) measurement tolerances, and therewith the unambiguity of the differentiation, and therewith the distinction of the alternative segments, can be undertaken.

These parameters can already be taken into consideration during the selection of the data to be made available and for reducing the set of data to be brought along and for simplification of the control of the evaluation algorithm. All data, which (due to their likelihood of confusion) need not be present for evaluation could be omitted, other parts of the data can be provided with parameters, which characterize the weight of this segment in an evaluation. With this variable weighting of the data for the comparison between measurements and descriptions of the various street tracks or courses one can rapidly and confidently compare long courses and branches, since competing streets are thereby represented by detailed data sets and thus can reliably be distinguished from one of the relevant tracks. The selection of the data or as the case may be the parameterization thus contributes essentially to the function of the evaluation algorithm.

FIG. 1 shows an example of a problematic situation. The decision point on the toll road segment a can be reached via feeder roads g, d-e or c-e. An alternative travel over the segment c-f-b passes very close to a decision point. In an evaluation at this position a clear decision must be made regarding the segment traveled.

In employment of the inventive process the street course must be described backwards to the direction of travel from the decision point, and be present in the data set of the evaluation device, so far until it so distinguishes itself from the competing street b, that it can no longer be confused with the detected measured values despite inherent tolerances. It can be seen from this example that the description of the course a is not sufficient. If for an evaluation only the segment a is known and the vehicle is actually traveling along path c-f-b, then the tolerances of the measurement results are not sufficient to provide an unambiguous decision. This shows that here the description of the course of the toll road against the direction of travel must occur out along at least one branch. Thus these branches must also be described to the extent that taking into consideration the tolerances the described branch and the rest of the paths up to the decision point they cannot be confused with another street track (clear differentiation of the measured values).

In the illustrated example according to FIG. 1 there must be present in the evaluation device as a data set, besides the road a, also a description of the branch e. Assuming that the tolerances of the sensor data are sufficiently precise in the example for determining direction of travel, the approach via e on the toll road a can be clearly distinguished from the segment c-f-b. The left/right curve then clearly distinguishes itself in the measured values from the right/left curve of the competing street. If the vehicle drives from the segment g into the toll segment a, then the obtained position values within the tolerances do not distinguish from those of segments b. Accordingly the evaluation would indicate a driving onto a as soon as segment b has been passed through. From this consideration it is clear that also the segments a and e do not suffice as description of the decision point. If however the segment g (as considered from the connection to the segment a) is described to the point that with consideration of the measurement tolerances the segment f is far enough away (for clear measured value distinctions) from the start point of the description, then the path c-f-b distinguishes itself clearly from path g-a. Therefore it follows that as the data set in the evaluation device these segments a, e and g are sufficient. FIG. 2 shows these areas as bold lines in the above example.

In accordance with the above-described requirements the set of data to be carried along in the evaluation unit should be as small as possible, in order to reduce memory and transmission costs. In any case, the data set must describe the course of the street up to the locations at which the competing tracks are sufficiently distinguishable, such that they can be reliably separated using the on-hand measuring devices. In the discussed example in the case of the corresponding tolerance ranges of the sensors the measured values on both competing street segments a and b could lead to the result that the toll road is being traveled upon. The measured values from these road segments hardly contribute to the decisive determination. From this one can conclude that the precise characterization of the course of the relevant road segment at these locations is not necessary. One can thus omit a description of these locations and limit oneself to other parameters or correlation considerations, such as distance or time window, and upon data elements, which describe the course of the actually relevant locations.

The representation in FIG. 3 shows an example of a minimal required description of the examined decision point. The precise locations of the road segments and in certain cases also the partial segments themselves are determined by the type and the tolerances of the sensors employed in the vehicle. The presetting or parameters, in which details and how far each partial segment is described in the on-board taken-along data sets, must be made by a central responsible for the quality of the decision. In this central thus a precision tolerance must be known both for position determination as well as for direction determination, which all available sensors obtain with a probability which corresponds to the permissible error rate. For the evaluation device there is then available the correct (minimal) amount of detail of descriptive data for the evaluation process.

As long as the measured values remain within the predetermined precision, it then is valid that on a competing road or side street a measurement can be produced, which could also have been measured on the toll-relevant road segment, even if all stipulated tolerances likewise have been utilized or exploited here. As a rule of thumb here it could be valid for example that the distance of the competing roads or as the case may be directions must be an amount that is more than twice the combined precision. This corresponds for the considered example to a data set which is present by the segments described in FIG. 3.

An even more encompassing description of the street relationships going beyond this minimal set can without more be put into direct employment. Thus, for example, also a data set can be employed, which was conceptualized for navigation applications. Therewith a consideration of the evaluation results as to consistency with these other map data can occur. A broader data set can also be employed in order to make possible a continuation of the measurements by “map matching” during a temporary loss of position sensors (for example in tunnels).

The algorithm used in the evaluation device must recognize the traveling of the complete course of the relevant sequence of streets, that is, from the beginning of the “branch” until a (for all branches common) decision point. An average data storage regarding the total course does not suffice in the case of longer segments. An advantageous method would be either to evaluate each measured value separately, for example whether it lies within or outside the agreed tolerances, or over short street segment “packets” of common measured values, for example, to evaluate with a “least square” file, in order to discount individual “outliers”.

The central service center, which describes for compilation of the data set the course of the street, taking into consideration the measurement tolerances of the evaluation devices, must, besides the precise agreement of the measurement tolerances, also precisely define the format which is used for transmission of these data into the evaluation device. Therein this format should be the same for all recognition locations, even if, due to the different conditions with regard to adjacent streets, the structures for these minimal data sets would be different. Further, the format of the data set should be so selected that in the evaluation device always the same algorithm or as the case may be the same software can be employed for the evaluation.

In accordance with the invention the expected diversity of the structures can be described by minimally described street courses in a recursive structure of “sequences” which form optional branches and then again plots or progressions. FIG. 4 shows an example of a data structure, which describes a complete street network, of which the elements must be recognized by an evaluation device, so that the traveled road segment is not confused with other street segments running in the vicinity.

The characteristics of an optimal coding of individual road segments to be recognized, for example, toll roads, can be described as follows:
Only street segments relevant for payment and in certain cases their entryways need be coded—however not competing roads, of which travel does not result in toll charge.
The algorithm, which provides a measurement of the probability that a street has been traveled, must judge the total indicated course and may not form an average regarding the stored data of the total segment.
Sufficient number of data must be available to the algorithm in the evaluation device for a decision or as the case may be must be transmitted by a center
Segments, for which there are competing alternatives which cannot be reliably distinguished using the measurement of the sensors at these locations, need not be explicitly described, since they do not contribute to the decision.
It could be necessary that the course of a street to be recognized must be described very far back—in certain cases with interruptions—until it distinguishes itself sufficiently from other competing streets, so that in the direction opposite to he direction of travel this branching must be described, which are then again subject to the same rules.
If in the exceptional cases it is not possible to exclude all competing street segments in an acceptable distance, then at a suitable location a transmitter beacon with a reduced communication zone is used to clearly characterize the recognition of the relevant street.
If a toll must be paid only in the case of traveling a longer partial segment than the distance between two entrances or exits, then in the description these entrance or exits can be omitted.

1. An evaluation process for recognition of traveled roads, which are for example toll roads, by comparison of data regarding the course of the street, which is stored in an evaluation device, with measurement values flawed with tolerances, for example with respect to position and direction of travel, which are provided by sensors present in the vehicle, wherein for the evaluation, data regarding the course of the street is consulted in the direction contrary to the direction of travel of the vehicle proceeding to a decision point, and which distinguish themselves from competing street segments, that is, street segments lying in the vicinity, which do not lead to the decision point, and that by means of the measurement values consulted for comparison, taking into consideration the tolerances, a traveling on the other street segment can be clearly excluded.

2. The evaluation process according to claim 1, wherein for the evaluation, data are also consulted regarding the track of streets opposite to the direction of travel over passed branches.

3. The evaluation process according to claim 1, wherein for the evaluation primarily data regarding street segments are consulted, which are so distant from competing street segments, that in these segments the measured values make possible a clear differentiation as a result of non-overlapping tolerance zones.

4. The evaluation process according to claim 1, wherein as data regarding street segments, which have zones of overlapping tolerance with competing street segments, preferably only indications regarding distance or different drive times are utilized.

5. The evaluation process according to claim 1, wherein the data consulted for evaluation regarding street segments are weighted according to diverse criteria, for example, with regard to acceptable error rates of the recognition precision, actual given sensor precision, number of the streets competing with the street segment, number of direction changes on a street segment, etc.

6. The evaluation process according to claim 1, wherein multiple measured values are consulted for comparison in the sense of a compensation for individual erroneous measurements.

7. The evaluation process according to claim 1, wherein supplemental additional data regarding the track of the street, for example from an available digital navigation map, are consulted for evaluation and/or for checking the results, for example with regard to consistency.

8. The evaluation process according to claim 1, wherein signals from support transmitter beacons are supplementally consulted in the evaluation.
